(19) United States
(12) Patent Application Publication
(10) Pub. No.: US 2008/0095239 A1
(43) Pub. Date: Apr. 24, 2008

(54) Method for video frame rate conversion

(75) Inventors: Yong-Hyun Lim, Suwon-si (KR); Jae-Hoon Kwon, Seongnam-si (KR); Yun-Je Oh, Yongin-si (KR); Young-Hun Joo, Yongin-si (KR)

Correspondence Address: CHA & REITER, LLC, 210 ROUTE 4 EAST STE 103, PARAMUS, NJ, 07652, US

(73) Assignee: Samsung Electronics Co., LTD

(21) Appl. No.: 11/897,393

(22) Filed: Aug. 30, 2007

(30) Foreign Application Priority Data
Oct. 20, 2006 (KR) 102299/2006

(51) Int. Cl. H04N 7/32

(52) U.S. Cl. 375/240.16

(57) ABSTRACT

Methods and apparatus for video frame rate conversion are disclosed. In one aspect of the invention, a basic interpolation motion vector for an interpolated frame is generated using a motion vector of a current frame. The motion vector of the current frame is compared with a motion vector of a previous frame. The basic interpolation motion vector is offset and corrected according to a comparison result. The interpolated frame is generated by performing motion compensation using at least one of the basic interpolation motion vector and the corrected basic interpolation motion vector.

### CLAIM OF PRIORITY

This application claims the benefit of the earlier filing date, under 35 U.S.C. §119, to that Korean patent application filed in the Korean Intellectual Property Office on Oct. 20, 2006 and assigned Serial No. 2006-102299, the entire disclosure of which is incorporated by reference herein.

### BACKGROUND OF THE INVENTION

1. Field of the Invention

The present invention relates video processing and specifically to a video frame rate conversion method using motion estimation in a technology for processing motion images as in the Moving Pictures Experts Group 4 (MPEG-4) standard.

2. Description of the Related Art

Frame rate conversion (FRC) for changing the number of frames output per second is a technology for converting a video sequence compressed at a low frame rate into a high frame rate. For example, the FRC is used when video data to be rendered at 15 frames per second, as in satellite digital multimedia broadcasting (DMB), for example, is rendered at 30 frames per second. A video decoder can perform the FRC function based on motion vectors (MVs) and decoded image signals.

The conventional FRC technology operates with the video decoder. The video decoder acquires information regarding a previous frame part related to an image of a specific block of a frame to be newly generated using decoded MVs. The video decoder properly corrects decoded MV information, generates the corrected MVs mapped to the image to be newly generated, and creates a new image using the generated MVs and decoded image signals.

When the corrected MVs mapped to the image to be newly generated are conventionally created, only MVs of a current decoded frame are used. At this time, a motion image to be currently processed is video encoded at a low frame rate. Since a time interval between frames is relatively large when the new frame is created only using the MVs of the current frame, the motion of objects constructing an image is viewed as being unnatural. That is, in the natural world, many objects slowly move along a curve rather than a straight line. Thus, when the new frame is created only using MVs of the current frame, video objects may move along the straight line at an angle according to each sampling time without slowly moving along a curve. Since an interval between frames is wide as a frame rate at which an image is encoded is low, an object moves along the straight line and the movement is viewed as being unpleasant to the user.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a video frame rate conversion method that can more naturally reproduce the motion of objects in comparison with the prior art.

In accordance with an aspect of exemplary embodiments of the present invention, there is provided a method for video frame rate conversion, including generating a basic interpolation motion vector for an interpolated frame using a motion vector of a current frame, comparing the motion vector of the current frame with a motion vector of a previous frame, offsetting and correcting the basic interpolation motion vector according to a result of the comparison, and generating the interpolated frame by performing motion compensation using at least one of the basic interpolation motion vector and the corrected basic interpolation motion vector.

### BRIEF DESCRIPTION OF THE DRAWINGS

The above and other features and advantages of the present invention will be more apparent from the following detailed description taken in conjunction with the accompanying drawings, in which:

FIG. 1 illustrates an example of the motion of one object according to time;

FIG. 2 illustrates an example of decoded motion vectors (MVs) mapped to the object of FIG. 1;

FIG. 3 illustrates an example of predicted MVs of one object for conventional frame rate conversion;

FIG. 4 is a flowchart illustrating a conventional frame rate conversion operation;

FIGS. 5 to 7 illustrate examples of MVs for explaining an algorithm for predicting the MVs of one object in frame rate conversion in accordance with an exemplary embodiment of the present invention;

FIG. 8 is a flowchart illustrating a frame rate conversion operation in accordance with an exemplary embodiment of the present invention; and

FIG. 9 is a block diagram illustrating a frame rate converter to which the present invention is applied.

### DETAILED DESCRIPTION OF THE INVENTION

Exemplary embodiments of the present invention will be described in detail herein below with reference to the accompanying drawings. In the following description, specific details such as specific components are set forth to provide a more thorough understanding of the present invention. However, it will be apparent to one skilled in the art that the present invention is not limited to these specific details.

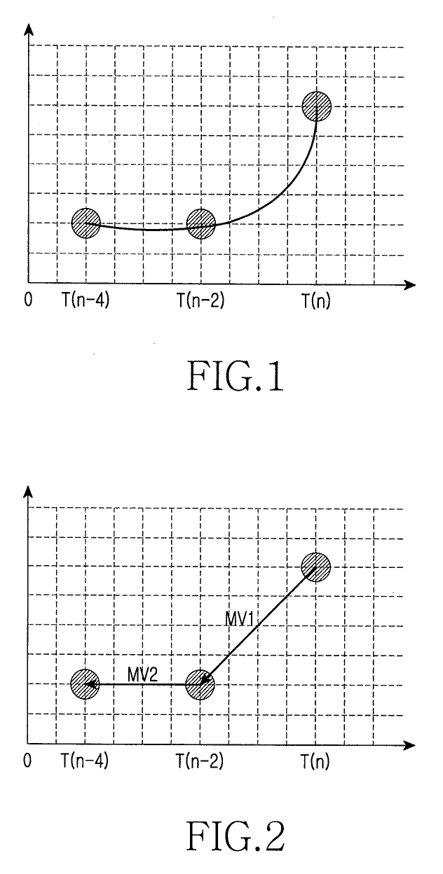

FIG. 1 illustrates an example of the motion of one object according to time. Referring to FIG. 1, a solid line indicates a motion path of the object before compression, and a black point indicates a decoded image after capturing and compressing video data, for example, at 15 frame rate per second (FPS). In FIG. 1, T(n) is a decoding time of a current frame, T(n-2) is a decoding time of a just previous frame, and T(n-4) is a decoding time of a previous frame before the just previous frame. Since objects of the natural world move along a slow curve, a motion path is shown as a solid line curve. In FIG. 1, it can be seen that high frequency motion of an intermediate path, is negligible, when decoding is performed after an image is captured and compressed as in an application of satellite digital multimedia broadcasting (DMB).

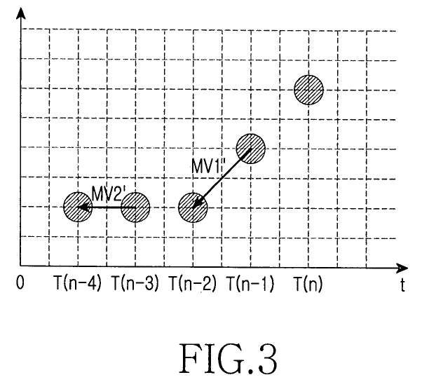

FIG. 2 illustrates an example of decoded motion vectors (MVs) mapped to the object of FIG. 1. Referring to FIG. 2, a video decoder provides decoded data and can acquire not only information regarding a decoded image but also motion vector information regarding a block of the decoded image. Frame rate conversion (FRC) is performed using the above-described two information elements. Using MVs and frame image information capable of being acquired by the video decoder, for example, a low frequency image at 15 FPS is converted into a high frequency image at 30 FPS, such that a more natural image can be provided to a user. Since an interval between frames is wide in the low frequency image at 15 FPS as illustrated in FIG. 2, the user may be inconvenienced upon reproduction as the reproduction is not a substantially similar match to the actual motion.

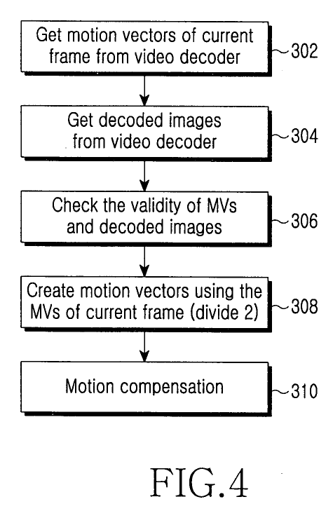

FIG. 3 illustrates an example of predicted MVs of an object in conventional FRC. As illustrated in FIG. 3, MVs of an object interpolated at times T(n-1) and T(n-3) are obtained by performing only an interpolation (e.g., “division by 2”) operation on current decoded MVs at times T(n) and T(n-2). In this case, slow curve motion is not shown at the time T(n-2) since MVs of an object of a previous frame are not considered. This problem occurs since images at the times T(n-1) and T(n-3) are recovered by considering only MVs of an object of the current frame.

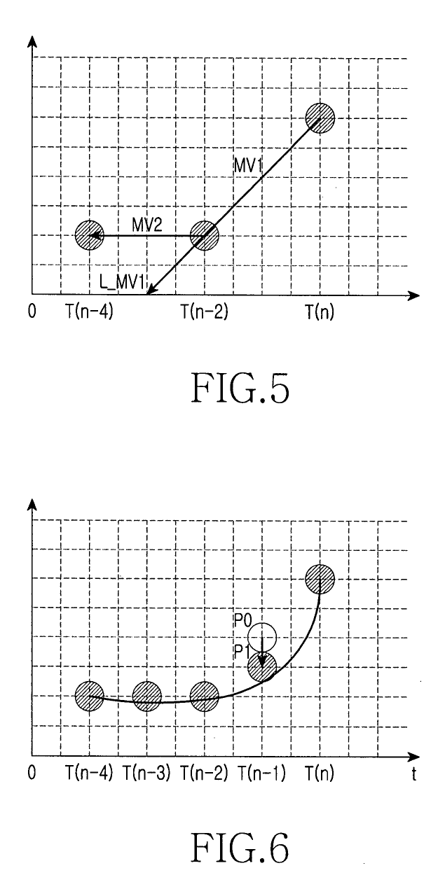

FIG. 4 is a flowchart illustrating a conventional FRC operation. Referring to FIG. 4, the conventional FRC operation first gets MVs mapped to a current frame from the video decoder (step 302) and obtains a decoded current frame block from a memory (step 304). Then, a correlation between a neighboring block and an image decoded with an MV in a specific position is checked (step 306). At this time, since the decoded MV is not a real MV, but is an MV mapped to a block in which a sum of absolute difference (SAD) between blocks is minimal, there is required a part for verifying how much it is similar to the neighboring block. Verification information is used upon motion compensation thereafter.

In order to create MVs of a frame to be interpolated using MVs of the current frame, the conventional algorithm performs the “division by 2” operation (step 308). Then, motion compensation of each pixel to be interpolated is made using the created MVs, the verification information and the current and previous frames (step 310). Consequently, an interpolated frame corresponding to an intermediate frame between the previous frame and the current frame is created.

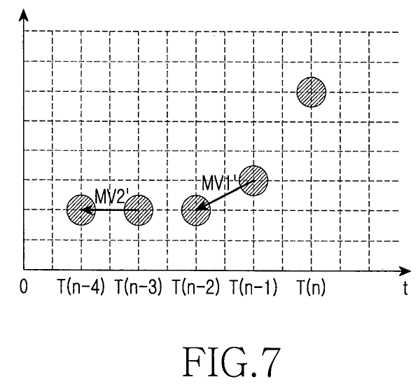

FIGS. 5 to 7 illustrate examples of MVs for explaining an algorithm for predicting the MVs of one object in FRC in accordance with an exemplary embodiment of the present invention. First, FIG. 5 illustrates a decoded MV1 of one object of a current frame and a straight line L_MV1 in its MV direction in an exemplary embodiment of the present invention. FIG. 6 illustrates a position correction state of the object. FIG. 7 illustrates MVs of the final object in an interpolated frame.

Referring to FIGS. 5 to 7, an exemplary embodiment of the present invention generates an image interpolated at a time T(n-1) by considering a relation between an MV of a current frame (at a time T(n)) and an MV of a previous frame (e.g., at a time T(n-2)). In detail, a straight line created by sufficiently increasing the MV1 length of one object of the current frame in a direction indicated by the arrow is referred to as L_MV1, as illustrated in FIG. 5. In the natural world, many objects smoothly move along a curve. If MV2 of an associated object of the previous frame indicates being to the right of the L_MV1 direction, the associated object moves from a P0 position to a path biased to the left of the L_MV 1 direction and then moves to an associated position at the time T(n). Therefore, the object creates a more natural video sequence at a position P1 than in the position P0 at the time T(n-1). Similarly, if MV2 indicates being left of the L_MV1 direction, the object moves from the PO position to a path biased to the right of the L_MV1 direction and then moves to an associated position at the time T(n).

When an object position is corrected as seen in FIG. 6, MVs of blocks constructing an image interpolated at the time T(n-1) are corrected as illustrated in FIG. 7. The conventional algorithm computes Equation (1) to create the corrected MVs such as MV1′ and MV2′ as illustrated in FIG. 7.

\vec{MV}ᵢ=\vec{MV}_{c}/2

if (\vec{MV}_{c}−\vec{MV}ₚ)>\vec{a}

\vec{MV}ᵢ=(\vec{MV}ᵢ−b)

else if (\vec{MV}_{c}−\vec{MV}ₚ)<−\vec{a}

\vec{MV}ᵢ=(\vec{MV}ᵢ+b) (1)

\vec{MV}_{c}: motion vector of current frame

\vec{MV}ₚ: motion vector of previous frame

\vec{MV}ᵢ: motion vector of interpolated frame

\vec{a}: threshold vector

\vec{b}: offset vector

Referring to Equation (1), a predefined offset vector is subtracted from an interpolated MV computed by the conventional algorithm if a value computed by subtracting the MV of an object within the previous frame from the MV of an object within the current frame is more than a predefined threshold vector. In this case, when MV2 indicates right of the L_MV1 direction in FIG. 5, the effect in which an interpolated object moves is to the left in the L_MV1 direction can be obtained due to the subtraction of the offset vector. On the other hand, the predefined offset vector is added to the interpolated MV computed by the conventional algorithm if the value computed by subtracting the MV of the object within the previous frame from the MV of the object within the current frame is less than the predefined threshold vector. In this case, when MV2 indicates left in the L_MV1 direction in FIG. 5, the effect in which the interpolated object moves is to the right in the L_MV1 direction can be obtained due to the addition of the offset vector. When the threshold vector is set, the interpolated MV computed by the conventional algorithm does not need to be corrected due to the insignificant correction effect if an angle of MV2 biased in the L_MV1 direction is not large.

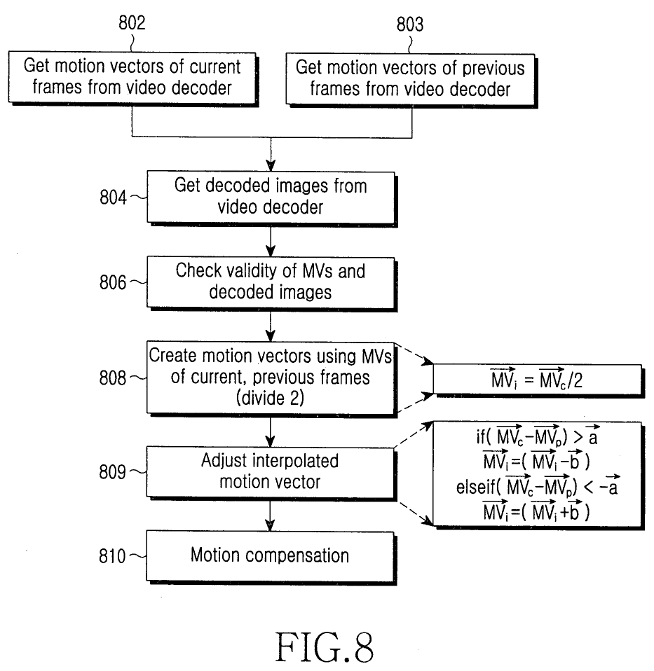

FIG. 8 is a flowchart illustrating an FRC operation in accordance with an exemplary embodiment of the present invention. Referring to FIG. 8, the FRC operation in accordance with the exemplary embodiment of the present invention obtains MVs mapped to a current frame from the video decoder (step 802) and obtains a decoded current frame block from a memory (step 803). To perform the FRC operation in accordance with the exemplary embodiment of the present invention, a previous frame block decoded with MVs of a previous frame is obtained from the memory (step 804). Then, a correlation between a neighboring block and an image decoded with an MV in a specific position is checked (step 806). Since the decoded MV is not a real MV, but is an MV mapped to a block in which an SAD between blocks is minimal, there is required a part for verifying how much it is similar to the neighboring block. Verification information is used upon motion compensation thereafter.

To compute an MV of a frame to be interpolated using MVs of the current frame, a “division by 2” (interpolation) operation is performed as in the conventional algorithm and an initial MV of a frame to be interpolated is computed (step 808). The interpolated MV is adjusted by considering directions of the MVs of the previous and current frames (step 809). An adjustment method uses Equation (1) as described with reference to FIGS. 6 and 7. Then, motion compensation of each pixel to be interpolated is made using the adjusted MV, the verification information, the current frame and the previous frame (step 810). Consequently, an interpolated frame corresponding to an intermediate frame between the previous frame and the current frame is created.

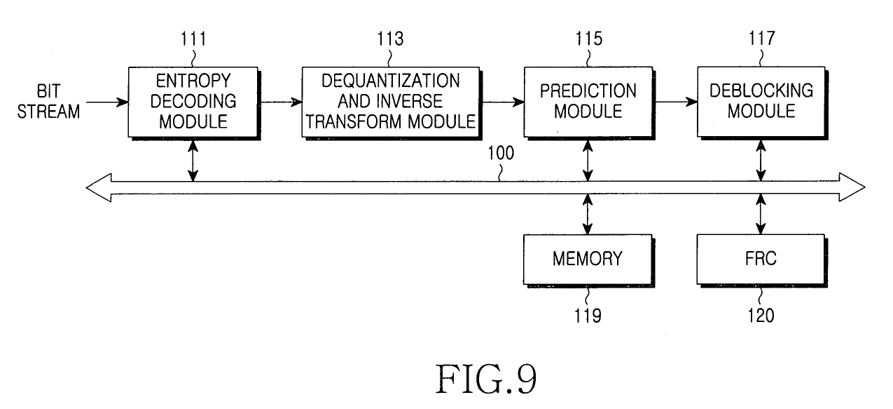

FIG. 9 is a block diagram illustrating a frame rate converter to which the present invention is applied. The frame rate converter can be an MPEG-4 or H.264 decoder or other similar decoder. Referring to FIG. 9, the decoder performs a decoding process in reverse order of an encoding process of an encoder. First, an entropy decoding module 111 entropy decodes a bit stream of a video coding layer (VCL) network abstraction layer (NAL) in a macroblock unit. In the VCL NAL, one frame is divided into multiple slices. One slice includes a slice header and a data field. Each piece of slice data includes one or more macroblocks.

A dequantization and inverse transform module 113 dequantizes and recovers, for example, discrete cosine transform (DCT) coefficients quantized upon encoding from the entropy-decoded data. The dequantization and inverse transform module 113 converts encoded DCT data into the original data. The converted data is provided to a prediction module 115 and is stored in a memory 119 through a data bus 100.

A prediction module 115 recovers the original image from a current macroblock by performing motion prediction and motion compensation on an input macroblock in intra- or inter-prediction mode. A recovery result is provided to a deblocking filter module 117 and is stored in the memory 119 through the data bus 100.

The deblocking filter module 117 performs a deblocking filtering process for a recovered image to reject the blocking effect between blocks. A deblocking filtering result is output to a subsequent stage and is simultaneously stored in the memory 119.

An FRC module 120 converts a frame rate using a frame-recovered image according to a feature of an exemplary embodiment of the present invention. FIG. 9 illustrates an example in which the FRC module 120 is included as a specific module within the decoder. The FRC module 120 may be installed in hardware outside the decoder such that the FRC module 120 can be constructed to operate with the decoder.

As described above, the video FRC operation in accordance with the exemplary embodiments of the present invention can be performed. While the invention has been shown and described with reference to certain exemplary embodiments of the present invention thereof, it will be understood by those skilled in the art that various changes in form and details may be made therein without departing from the spirit and scope of the present invention. For example, a process for subtracting and adding a predefined size offset vector has been described when a basic interpolation MV is offset. Alternatively, for example, a variable size offset vector can be added or subtracted according to a difference between MVs of current and previous frames. A process for generating one interpolated frame for each of the original 15 frames in accordance with the exemplary embodiments of the present invention has been described when frame conversion from 15 FPS to 30 FPS is performed. Alternatively, at least two interpolated frames can be generated between the original frames.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be rendered by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

Various modifications, additions, and substitutions of the present invention are possible. Therefore, the present invention is not limited to the above-described embodiments, but is defined by the following claims, along with their full scope of equivalents.

What is claimed is:

1. A method for video frame rate conversion, comprising the steps of:
generating a basic interpolation motion vector for an interpolated frame using a motion vector of a current frame;
comparing the motion vector of the current frame with a motion vector of a previous frame;
offsetting and correcting the basic interpolation motion vector according to a result of the comparison; and
generating the interpolated frame by performing motion compensation using at least one of the basic interpolation motion vector and the corrected basic interpolation motion vector.

2. A method for video frame rate conversion, comprising the steps of:
generating a basic interpolation motion vector for an interpolated frame using a motion vector of a current frame;
comparing the motion vector of the current frame with a motion vector of a previous frame;
offsetting and correcting the basic interpolation motion vector when a difference between the motion vectors of the current and previous frames is different from a predefined threshold as a comparison result; and
generating the interpolated frame by performing motion compensation using at least one of the basic interpolation motion vector and the corrected basic interpolation motion vector.

3. The method of claim 2, wherein offsetting the basic interpolation motion vector comprises:
subtracting a predefined offset vector from the basic interpolation motion vector when the difference between the motion vectors of the current and previous frames is more than a first threshold vector; and
adding a predefined offset vector to the basic interpolation motion vector when the difference between the motion vectors of the current and previous frames is less than a second threshold vector.

4. The method of claim 1, wherein offsetting the basic interpolation motion vector comprises the step of:
offsetting the basic interpolation motion vector in a size based on the difference between the motion vectors of the current and previous frames.

5. A method for video frame rate conversion, comprising:
obtaining motion vectors of current and previous frames and blocks of decoded current and previous frames;
checking and verifying a correlation between a block decoded with a motion vector of the current frame and a neighboring block;
computing an initial interpolation motion vector of a frame to be interpolated by performing a division by 2 operation using the motion vector of the current frame;
correcting the initial interpolation motion vector using an equation according to directions of the motion vectors of the current and previous frames: and
generating an interpolated frame by performing motion compensation of each pixel of the frame to be interpolated using the corrected interpolation motion vector, verification information and the current and previous frames,
wherein the equation is defined by:
\vec{MV}ᵢ=\vec{MV}_{c}/2
if (\vec{MV}_{c}−\vec{MV}ₚ)>\vec{a}
\vec{MV}ᵢ=(\vec{MV}ᵢ−b)
else if (\vec{MV}_{c}−\vec{MV}ₚ)<−\vec{a}
\vec{MV}ᵢ=(\vec{MV}ᵢ+b)
\vec{MV}_{c}: motion vector of current frame
\vec{MV}ₚ: motion vector of previous frame
\vec{MV}ᵢ: motion vector of interpolated frame
\vec{a}: threshold vector
\vec{b}: offset vector

6. The method of claim 2, wherein offsetting the basic interpolation motion vector comprises the step of:
offsetting the basic interpolation motion vector in a size based on the difference between the motion vectors of the current and previous frames.

7. An apparatus for video frame rate conversion, comprising:
a processor in communication with a memory, the processor when loaded with computer executable code, executing the steps of:
generating a basic interpolation motion vector for an interpolated frame using a motion vector of a current frame;
comparing the motion vector of the current frame with a motion vector of a previous frame;
offsetting and correcting the basic interpolation motion vector according to a result of the comparison; and
generating the interpolated frame by performing motion compensation using at least one of the basic interpolation motion vector and the corrected basic interpolation motion vector.

8. An apparatus for video frame rate conversion comprising:
a processor in communication with a memory, the processor when loaded with computer executable code, executing the steps of:
generating a basic interpolation motion vector for an interpolated frame using a motion vector of a current frame;
comparing the motion vector of the current frame with a motion vector of a previous frame;
offsetting and correcting the basic interpolation motion vector when a difference between the motion vectors of the current and previous frames is different from a predefined threshold as a comparison result; and
generating the interpolated frame by performing motion compensation using at least one of the basic interpolation motion vector and the corrected basic interpolation motion vector.

9. The apparatus of claim 8, wherein offsetting the basic interpolation motion vector comprises:
subtracting a predefined offset vector from the basic interpolation motion vector when the difference between the motion vectors of the current and previous frames is more than a first threshold vector; and
adding a predefined offset vector to the basic interpolation motion vector when the difference between the motion vectors of the current and previous frames is less than a second threshold vector.

10. The method of claim 7, wherein offsetting the basic interpolation motion vector comprises the step of:
offsetting the basic interpolation motion vector in a size based on the difference between the motion vectors of the current and previous frames.

11. An apparatus for video frame rate conversion comprising:
a processor in communication with a memory, the processor when loaded with computer executable code, causing the processor to execute the steps of:
obtaining motion vectors of current and previous frames and blocks of decoded current and previous frames;
checking and verifying a correlation between a block decoded with a motion vector of the current frame and a neighboring block;
computing an initial interpolation motion vector of a frame to be interpolated by performing an interpolation operation using the motion vector of the current frame;
correcting the initial interpolation motion vector using an equation according to directions of the motion vectors of the current and previous frames: and
generating an interpolated frame by performing motion compensation of each pixel of the frame to be interpolated using the corrected interpolation motion vector, verification information and the current and previous frames,
wherein the equation is defined by:
\vec{MV}ᵢ=\vec{MV}_{c}/2
if (\vec{MV}_{c}−\vec{MV}ₚ)>\vec{a}
\vec{MV}ᵢ=(\vec{MV}ᵢ−b)
else if (\vec{MV}_{c}\vec{MV}ₚ)<−\vec{a}
\vec{MV}ᵢ=(\vec{MV}ᵢ+b)
\vec{MV}_{c}: motion vector of current frame
\vec{MV}ₚ: motion vector of previous frame
\vec{MV}ᵢ: motion vector of interpolated frame
\vec{a}: threshold vector
\vec{b}: offset vector

12. The apparatus of claim 8, wherein offsetting the basic interpolation motion vector comprises the step of:
offsetting the basic interpolation motion vector in a size based on the difference between the motion vectors of the current and previous frames.

13. An apparatus for video frame rate conversion comprising:
means for obtaining motion vectors of current and previous frames and blocks of decoded current and previous frames;
means for checking and verifying a correlation between a block decoded with a motion vector of the current frame and a neighboring block;
means for computing an initial interpolation motion vector of a frame to be interpolated by performing a division by 2 operation using the motion vector of the current frame;
means for correcting the initial interpolation motion vector using an equation according to directions of the motion vectors of the current and previous frames: and means for generating an interpolated frame by performing motion compensation of each pixel of the frame to be interpolated using the corrected interpolation motion vector, verification information and the current and previous frames, wherein the equation is defined by:
\vec{MV}ᵢ=\vec{MV}_{c}/2
if (\vec{MV}_{c}−\vec{MV}ₚ)>\vec{a}
\vec{MV}ᵢ=(\vec{MV}ᵢ−b)
else if (\vec{MV}_{c}−\vec{MV}ₚ)<−\vec{a}
\vec{MV}ᵢ=(\vec{MV}ᵢ+b)
\vec{MV}_{c}: motion vector of current frame
\vec{MV}ₚ: motion vector of previous frame
\vec{MV}ᵢ: motion vector of interpolated frame
\vec{a}: threshold vector
\vec{b}: offset vector
